(19) United States
(12) Patent Application Publication
(10) Pub. No.: US 2012/0177987 A1
(43) Pub. Date: Jul. 12, 2012

(54) Composition of a Fluorinated Organic Carbonate and a Lewis Acid

(75) Inventors: Jens Olschimke, Hannover (DE); Martin Bomkamp, Hannover (DE); Andreas Grossmann, Sehnde (DE)

(73) Assignee: SOLVAY SA, Brussels (BE)

(21) Appl. No.: 13/497,333

(22) PCT Filed: Sep. 27, 2010
(86) PCT No.: PCT/EP10/64269

§ 371 Date: Mar. 21, 2012

(30) Foreign Application Priority Data
Sep. 28, 2009 (EP) 09171491.5

(51) Int. Cl. H01M 10/02; C09K 3/00

(52) U.S. Cl. 429/189; 252/364

(57) ABSTRACT

A method for handling fluorinated organic carbonates such that degradation reactions are minimized or even completely suppressed and hence initial purity of fluorinated organic carbonates is essentially maintained during handling. Compositions comprising a fluorinated organic carbonate with improved stability against degradation reactions. The compositions comprise equal to or less than 500 ppm of a Lewis acid.

### CROSS-REFERENCE TO RELATED APPLICATIONS

The present application is a U.S. national stage entry under 35 U.S.C. §371 of International Application No. PCT/EP2010/064269 filed Sep. 27, 2010, which claims priority benefit of European patent application number 09171491.5 filed on Sep. 28, 2009, the complete content of this application being incorporated herein by reference for all purposes.

### TECHNICAL FIELD OF THE INVENTION

The present invention concerns a composition of a fluorinated organic carbonate and a Lewis acid and a method for handling a composition comprising a fluorinated organic carbonate and a Lewis acid. It further relates to the use of said composition for the manufacture of electrolyte material for lithium ion batteries.

### BACKGROUND

Fluorinated organic carbonates are useful as solvents and additives for lithium ion batteries, and as dielectric for capacitors. JP patent application 08-222485 mentions that difluoroethylene carbonate and tetrafluoroethylene carbonate are suitable as dielectric for capacitors.

### SUMMARY OF THE PRESENT INVENTION

The inventors of the present invention observed that fluorinated carbonates sometimes are decomposed and undertook investigations to find out what caused the decomposition.

The present invention provides fluorinated organic carbonates which are particularly suitable in uses such as contemplated here before and are more resistant to decomposition.

The present invention provides inter alia a method for handling fluorinated organic carbonates and for fluorinated carbonates having a specifically low Lewis acid content such that degradation reactions are minimized or even completely suppressed and hence initial purity of fluorinated organic carbonates is essentially maintained during handling. The invention further provides compositions comprising a fluorinated organic carbonate with improved stability against degradation reactions. These objects and other objects are achieved by the invention as outlined in the claims and the description.

### DETAILED DESCRIPTION OF THE PREFERRED EMBODIMENTS

According to the present invention, if has been found advantageous to keep, the content of Lewis acid and preferably protic compounds, e.g., water and HF at a low level.

According to the present invention, a method for handling a composition of a fluorinated organic carbonate and at least one Lewis acid is provided which comprises maintaining the molar concentration of Lewis acid in the composition in an amount of equal to or lower than 500 ppm molar, preferably, in a range of 0.1 to 500 ppm molar relative to the total amount of fluorinated organic carbonate and Lewis acid and wherein the Lewis acid contains at least one cation selected from the Group IIB, IIIA, IIIB, IVA, IVB, VB, VIB or VIIIB elements of the Periodic Table. The Lewis acid content may even be lower than 0.1 ppm molar, down to 0 ppm.

It has been found that fluorinated organic carbonates in which the molar concentration of Lewis acid is maintained in the range above, are particularly suitable for their intended uses. The loss at the manufacturing site and rejection by the user of batches or containers of fluorinated organic carbonates can be substantially avoided. In particular the fluorinated organic carbonates do not (or substantially not) decompose during their application, but even from the moment of their manufacture until they are applied.

The inventors found that Lewis acids, or the presence of protic compounds, for example, of water and/or of HF per se do not necessarily induce decomposition of the fluorinated organic carbonates with pressure build-up but that decomposition is observed when the Lewis acid and at least one compound selected from water and HF is present in the fluorinated carbonate. Thus, while the presence of the Lewis acid may not be detrimental per se, nevertheless it is advantageous if the content of Lewis acids in the fluorinated carbonate is in the given range. It is preferred if the amount of protic compounds is equal to or lower than 100 ppm by weight. The term “protic compounds” denotes in particular compounds with a pk_{S} value of 7. The term especially denotes water and HF. The content of water is preferably equal to or lower than 50 ppm by weight, and the content of HF is preferably equal to or lower than 50 ppm by weight. More preferably, the content of water is equal to or lower than 20 ppm by weight, and the content of HF is equal to or lower than 20 ppm by weight.

The Periodic Table referred to is that described in “The Encyclopedia of Chemistry”, Reinhold Publishing Corporation, 2nd Ed. (1966) at page 790. The term “elements” as used herein refers to the metals and metalloids of the aforementioned Groups of the Periodic Table.

In the context of the present invention, the singular form is intended to include the plural, unless otherwise specified; and the plural is intended to include the singular unless otherwise specified. Thus, the term “fluorinated organic carbonate” means that a single fluorinated organic carbonate compound or a mixture of fluorinated organic carbonate compounds can be concerned. The term “a Lewis acid” means that one or more Lewis acids are present in the composition.

The method of the present invention allows improving the stability of the composition of a fluorinated organic carbonate and at least one Lewis acid, in particular to improve the stability of a composition being susceptible to degradation. It was found that the life time of said composition has been increased.

The fluorinated organic carbonates of the present invention are generally fluorinated dialkyl carbonates or fluorinated alkylene carbonates. They can be manufactured, for example, from unfluorinated carbonates, from dialkyl carbonates or alkylene carbonates with a lower degree of fluorination, or from chlosubstituted carbonates by electrofluorination, chlorine-fluorine exchange reactions or by fluorination with elemental fluorine. Fluoroalkyl(fluoro)alkyl carbonates may also be manufactured as described in unpublished international patent application PCT/EP2010/059795 from fluoroalkyl fluoroformates. Fluoroalkyl fluoroformates can be prepared from aldehydes and carbonyl fluoride.

4-fluoro-4-R-5-R′-1,3-dioxolane-2-ones wherein R is alkyl and R′ is H or a C1 to C3 group comprising a step of cyclization of compounds of formula (II), FC(O)OCHR′C(O)R wherein R is alkyl and R′ is H or a C1 to C3 group, or comprising the steps of cyclization of compounds of formula (II′), ClC(O)OCHR′C(O)R wherein R is alkyl and R′ is H or a C1 to C3 group and of subsequent chlorine-fluorine exchange may also be prepared as described in unpublished international patent application PCT/EP2010/057281. When the fluorinated organic carbonate is a dialkyl carbonate, the alkyl groups thereof can be the same or different and preferably denote C1 to C4 alkyl groups. They may be different and preferably denote methyl or ethyl, or they are, preferably, the same and denote methyl or ethyl. When the fluorinated organic carbonate is an alkylene carbonate, the term “alkylene” denotes preferably a C2 to C6 alkylene group.

Preferably, the fluorinated organic carbonates of the present invention are selected from the group consisting of fluorinated dimethyl carbonate, fluorinated ethylene carbonate, fluorinated diethyl carbonate, fluorinated ethyl methyl carbonate, fluorinated propylene carbonate and mixtures of two or more of them.

Typical examples of fluorinated diethyl carbonates are 1-fluoroethyl ethyl carbonate, bis(1-fluoroethyl)carbonate, 2-fluoroethyl ethyl carbonate, bis(2-fluoroethylcarbonate), 1,1-difluoroethyl ethyl carbonate, bis(1,1-difluoroethyl)carbonate, 2,2-difluoroethyl ethyl carbonate, bis(2,2-difluoroethyl)carbonate, 2,2,2-trifluoroethyl ethyl carbonate, bis(2,2,2-trifluorethylcarbonate), 1-fluoroethyl 2-fluoroethyl carbonate, 1-fluoroethyl 2,2-difluoroethyl carbonate, 1-fluoroethyl-2,2,2-trifluoroethyl carbonate, 1,1-difluoroethyl-2-fluoroethyl carbonate, 1,1-difluoroethyl-2-2-difluoroethyl carbonate, 1,1-difluoroethyl-2,2,2-trifluoromethylcarbonate. Fluorinated diethyl carbonates can be prepared, for example, by direct fluorination of dimethyl carbonate with elemental fluorine, by chlorine-fluorine exchange reactions (e.g., Halex reaction) from the respective chlorosubstituted carbonate, or by electrofluorination.

Typical examples of fluorinated ethyl methyl carbonates are fluoromethyl ethyl carbonate, 1-fluoroethyl methyl carbonate, 2-fluoroethyl methyl carbonate, 1,1-difluoroethyl methyl carbonate, difluoromethyl ethyl carbonate, methyl-1,1,2-trifluoroethyl carbonate, methyl-1,1,2,2-tetrafluoroethyl carbonate, methyl-1,1,2,2,2-pentafluoroethyl carbonate, 1-fluoroethyl fluoromethyl carbonate, 1-fluoroethyl difluoromethyl carbonate, 1-fluoroethyl trifluoromethyl carbonate, 2-fluoroethyl fluoromethyl carbonate, 2-fluoroethyl difluoromethyl carbonate, 2-fluoroethyl trifluoromethyl carbonate, 1,1-difluoroethyl fluoromethyl carbonate, 1,1-difluoroethyl difluoromethyl carbonate, 1,1-difluoroethyl trifluoromethyl carbonate, fluoromethyl-1,1,2-trifluoroethyl carbonate, difluoromethyl-1,1,2-trifluoroethyl carbonate, 1,1,2-trifluoroethyl trifluoromethyl carbonate, fluoromethyl-1,1,2,2-tetrafluoroethyl carbonate, difluoromethyl-1,1,2,2-tetrafluoroethyl carbonate, 1,1,2,2-tetrafluoroethyl trifluoromethyl carbonate, fluoromethyl-1,1,2,2,2-pentafluoroethyl carbonate, difluoromethyl-1,1,2,2,2-pentafluoroethyl carbonate and 1,1,2,2,1-pentafluoroethyl trifluoromethyl carbonate. Fluorinated ethyl methyl carbonates can be prepared, for example, by direct fluorination of dimethyl carbonate with elemental fluorine, by chlorine-fluorine exchange reactions (e.g., Halex reaction) from the respective chlorosubstituted carbonate, or by electrofluorination.

When the fluorinated organic carbonate is an ethylene carbonate, it can be monofluorinated, difluorinated, trifluorinated and tetrafluorinated. When the fluorinated organic carbonate is a propylene carbonate it can be mono-fluorinated, difluorinated, trifluorinated, tetrafluorinated, even pentafluorinated and hexafluorinated. The carbonates with more than 1 fluorine substituent are especially susceptible to decomposition. The effect of the invention is especially valuable, for commercial reasons, for mono-, di- and trifluorinated compounds.

The higher fluorinated compounds may exist in isomers. These isomers are for example produced when, as described above, elemental fluorine is reacted with non-fluorinated organic carbonates or with fluorinated organic carbonates with a lower degree of fluorination, e.g., with the monofluorinated organic carbonates. Preferably, the fluorinated organic carbonates of the present invention are selected from the group consisting of fluoromethyl methyl carbonate, difluoromethyl methyl carbonate, bis-(fluoromethyl)carbonate, fluoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one), difluoromethyl ethylene carbonate (or 4-difluoromethyl-1,3-dioxolane-2-one), 4-methyl-4-fluoro-1,3-dioxolane-2-one, cis-4-methyl-5-fluoro-1,3-dioxolane-2-one, trans-4-methyl-5-fluoro-1,3-dioxolane-2-one, 4-fluoromethyl-4-fluoro-1,3-dioxolane-2-one, 4-fluoromethyl-5-fluoro-1,3-dioxolane-2-one, 4-methyl-4,5-difluoro-1,3-dioxolane-2-one, Z-4-methyl-4,5-difluoro-1,3-dioxolane-2-one, fluoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one) and mixtures of two or more thereof.

Also esters with the formula XC(F)(H)—C(O)OR wherein X is H or CH₃ and R denotes phenyl, allyl, 2,2,2-trifluoroethyl and 2-methoxyethyl be contained as carbonate in the compositions.

The fluorinated organic carbonates according to the invention are preferably prepared by the reaction with elemental fluorine of a starting material selected from the respective non-fluorinated organic carbonates, and from fluorinated organic carbonates with a lower degree of fluorination.

Often, fluorination with elemental fluorine is performed with a neat starting material or with the starting material dissolved in a suitable solvent, for example, fluorinated carbonate functioning as a solvent, hydrogen fluoride or a perfluorocarbon. The elemental fluorine is often diluted by nitrogen; highly suitable mixtures contain 15 to 25% by volume of fluorine, the remainder being nitrogen. Fluorination is performed at lower temperatures for preparation of fluorinated organic carbonates with a lower degree of fluorination, e.g., in a range from −20° C. to 40° C. To obtain higher fluorinated organic carbonates, the reaction temperature may be slightly higher.

In general, the term “Lewis acid”, in the context of the present invention, denotes organometallic and, especially inorganic Lewis acids.

In a preferred embodiment, the inorganic Lewis acid may be selected from a group of compounds including, but not being limited to, inorganic halides and inorganic oxides. Inorganic halides are preferred Lewis acids.

Preferably, the inorganic halides have the formula MXₙ wherein M is a component selected from the Group IIB, IIIA, IIIB, IVA, IVB, VA, VB, VIB or VIIIB Elements of the Periodic Table or their mixtures, X is a halogen, n is the atomic ratio of halogen to M and varies from 1-7. Preferably, M is selected from the Group IIIA, IVA, VA, or VIIIB, group IIIA being most preferred. M preferably is Fe, Cr, Ni, Cu, and Al. X can be considered to be a single type of halogen even though it should be understood that X could refer to a mixed halogen such that MXₙ could be, for example, AlClF₂.

Preferably, X is a chloride or a fluoride anion. More preferably, X is fluoride. Examples of inorganic chloride Lewis acids are AlCl₃, SnCl₄, FeCl₃, NiCl₂, FeCl₂, FeCl₃, CuCl₂, NbCl₅, TiCl₄, and ZnCl₂. Examples of chlorofluorosubstituted aluminium halides is AlCₓlF_{y} wherein x+y are 3 and 0<x<3. Examples of inorganic fluoride Lewis acids are AlF₃, BF₃, NiF₂, FeF₃, PF_{S}, SbF₅, and AsF₅. More preferred inorganic fluoride Lewis acids are AlF₃ or BF₃. Most preferred inorganic fluoride Lewis acids is AlF₃. Typical examples of inorganic oxides are Fe₂O₃ and Al₂O₃.

In general, Lewis acids are compounds which can accept an electron pair. It has been found that interaction of Lewis acids with fluorinated organic carbonates in the presence of protic substances, especially in the presence of water and/or HF can result in the production of degradation products such as hydrogen fluoride. It was observed that glass, for example, may form HF and water and, if comprised, AlF₃, and it was found that when a low concentration of Lewis acid is present, the undesired potential degradation of fluorinated organic carbonates can be controlled and substantially avoided, thus limiting need for purification of fluorinated organic carbonates. For this reason, it has been found desirable to maintain the molar concentration of Lewis acid in the composition in a range of 0.1 to 500 ppm molar relative to the total amount of fluorinated organic carbonate and Lewis acid. A concentration of approximately 0 ppm is especially desirable.

The molar concentration of Lewis acid in the composition is advantageously equal to or lower than 250 ppm molar, preferably equal to or lower than 100 ppm molar, preferably equal to or lower than 50 ppm molar, more preferably equal to or lower than 20 ppm molar, very preferably equal to or lower than 10 ppm molar, and most preferably equal to or lower than 5 ppm molar relative to the total amount of fluorinated organic carbonate and Lewis acid.

The molar concentration of Lewis acid in the composition may be equal to or greater than 0 ppm molar relative to the total amount of fluorinated organic carbonate and Lewis acid.

Good results have been obtained for maintaining the molar concentration of Lewis acid in the composition in a range of greater than 0.1 to equal to or lower than 20 ppm molar relative to the total amount of fluorinated organic carbonate and Lewis acid. Very good results have been achieved for maintaining the molar concentration of Lewis acid in the composition in a range of greater than 0.1 to equal to or lower than 10 ppm molar relative to the total amount of fluorinated organic carbonate and Lewis acid. Very good results have been achieved for maintaining the molar concentration of Lewis acid in the composition in a range of greater than 0.1 to equal to or lower than 5 ppm molar relative to the total amount of fluorinated organic carbonate and Lewis acid.

In the method according to the invention, the molar concentration of the Lewis acid in the composition is generally maintained in the range of up to 250 ppm molar after the purification at least during the shelf life. The shelf life is often at least 6 months and can be longer.

Fluorinated organic carbonates appear sensitive towards dehydrofluorination (formation of HF) if they are exposed to high temperatures. The formed HF can react with at least one Lewis acid in the composition under formation of at least one other Lewis acid. For example, aluminium oxide can form Al—F bonds when contacted with HF. The resulting Lewis acids could induce decomposition of the fluorinated organic carbonates. Accordingly, in the method of the present invention, the composition of a fluorinated organic carbonate and at least one Lewis acid is generally maintained at a temperature equal to or lower than 200° C. during the purification. During other stages until being used, especially during the stages of storing and incorporation into an electrolyte solution, preferably in a range from 0° C. to 80° C. Often, the temperature is maintained from 10° C. to 60° C. Preferably, it is maintained from 20° C. to 30° C.

In the present invention, the term “handling” is understood to denote in particular an operation selected from the group consisting of manufacture, purification, storage, transport, filling and formulation.

For the purpose of the present invention, the term “manufacture” refers in particular to the steps of manufacturing the fluorinated organic carbonate, especially by the reaction of non-fluorinated organic carbonates with elemental fluorine, or from fluorinated organic carbonates with a lower degree of fluorination with elemental fluorine, in particular as described herein above. In a particular aspect, manufacture may notably comprise keeping the composition of the present invention in at least one reactor and passing the composition of the fluorinated organic carbonate and the Lewis acid through equipment such as for example pipes, valves, walls, mixing apparatus, introduction units, packing, devices for measuring temperature and pressure, coolers. For the purpose of the present invention, the term “purification” refers in particular to the separation of purified fluorinated organic carbonate from at least one impurity. Impurities typically include HF and ethylene carbonate. Purification often comprises one or more steps selected from the group consisting of distillation, stripping, crystallization and precipitation.

For the purpose of the present invention, the term “storage” refers in particular to the step of storing the composition of the fluorinated organic carbonate and the Lewis acid in a container selected in particular from a group consisting of bottles, tanks and drums. In a particular aspect, the may comprise passing the composition according to the invention acid through pumps, pipes or lines between storage containers.

For the purpose of the present invention, the term “transport” refers in particular to the transporting the composition according to the invention in a transport container. The transport container is suitably selected from the group consisting of bottles, tanks and drums. The transport container can be transported, for example, on a lorry or a railway wagon or a ship. The term “transport” may further comprise passing said composition through pumps, pipes or lines between storage containers and transport containers.

For the purpose of the present invention, the term “formulation” refers to the mixing of the composition of the present invention with at least one other component of an electrolyte mixture or an electrolyte solution, An example of such component is an additional solvents. Suitable additional solvents are, e.g., lactones, formamides, pyrrolidinones, oxazolidinones, nitroalkanes, N,N-substituted urethanes, sulfolane, dialkyl sulfoxides, dialkyl sulfites, and trialkylphosphates or alkoxyesters pyrocarbonates, alkyl acetates, N,N-disubstituted acetamides, sulfoxides, nitriles, glycol ethers and ethers. The mixture of the fluorinated organic carbonate with ethylene carbonate, propylene carbonate dimethyl carbonate, diethyl carbonate or ethyl methyl carbonate is preferred. The mixtures optionally also include Li salt, e.g., LiPO₂F₂, LiBF₂C₂O₄ (LiFOB), LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O_{8 (“LiBOB”), or Li(C}₂F₅)PF₃, and especially LiPF₆. In particular, the electrolyte mixtures or electrolyte solutions are suitable for lithium ion batteries.

In preferred aspects, the term “handling” comprises the manufacture of the composition, the purification of the composition and the storage of the composition. More preferably, the term “handling” refers to storage of the composition according to the invention.

In a first specific embodiment of the present invention, the Lewis acid is provided to the composition by contact of the fluorinated organic carbonate with at least one part during handling.

In a second embodiment, the Lewis acid is formed from a Lewis acid precursor.

In the following, the first specific embodiment is explained in detail.

The term “parts” denotes especially the equipment used during handling.

For the purpose of the present invention, the equipment used during manufacture is selected from a group consisting of a reactor, pipes, valves, walls, mixing apparatus, introduction units, packing, devices for measuring temperature and pressure, coolers. Suitable packings are, for example, Raschig rings and pall rings.

For the purpose of the present invention, the equipment used during purification is selected from a group consisting of stripping columns, adsorption devices, distillation columns, crystallisators and precipitation apparatus.

For the purpose of the present invention, the equipment used during storage is selected from the group consisting of bottles, tanks, drums, apparatus for filling, pumps, pipes or lines between storage containers.

For the purpose of the present invention, the equipment used during transport is selected from the group consisting of bottles, tanks, drums, pumps, pipes and lines between transport containers.

For the purpose of the present invention, the equipment used during formulation is selected from the group consisting of mixing apparatus, e.g., static mixers, mixers with stirrer.

In a first aspect of the first embodiment of the method of the present invention, the molar concentration of Lewis acid in the composition is during manufacturing advantageously in a range of 0.1 to 100 ppm molar, relative to the total amount of fluorinated organic carbonate and Lewis acid, preferably in a range of 0.1 to 50 ppm molar, more preferably in a range of 0.1 to 20 ppm molar, very preferably in a range of 0.1 to 10 ppm molar relative to the total amount of fluorinated organic carbonate and Lewis acid, and most preferably, in a range of 0.1 to 5 ppm molar relative to the total amount of fluorinated organic carbonate and Lewis acid.

In this first aspect, the composition according to the invention is generally maintained at a temperature equal to or lower than 100° C., preferably in a range from 0° C. to 80° C.

In a second aspect of the first embodiment of the method of the present invention, the molar concentration of Lewis acid in the composition is during purification advantageously in a range of 0.1 to 100 ppm molar, relative to the total amount of fluorinated organic carbonate and Lewis acid, preferably in a range of 0.1 to 50 ppm molar, more preferably in a range of 0.1 to 25 ppm molar, very preferably in a range of 0.1 to 10 ppm molar relative to the total amount of fluorinated organic carbonate and Lewis acid, and most preferably in a range of 0.1 to 5 ppm molar relative to the total amount of fluorinated organic carbonate and Lewis acid.

In this second aspect of the first embodiment of the method of the present invention, the composition of a fluorinated organic carbonate and at least one Lewis acid is generally maintained at a temperature equal to or lower than 200° C., preferably in a range from 0° C. to 200° C.

In a third aspect of the first embodiment of the method of the present invention, the molar concentration of Lewis acid in the composition is during storage advantageously in a range of 0.1 to 100 ppm molar, relative to the total amount of fluorinated organic carbonate and Lewis acid, preferably in a range of 0.1 to 50 ppm molar, more preferably in a range of 0.1 to 25 ppm molar, very preferably in a range of 0.1 to 10 ppm molar relative to the total amount of fluorinated organic carbonate and Lewis acid, and most preferably in a range of 0.1 to 5 ppm molar relative to the total amount of fluorinated organic carbonate and Lewis acid.

In this third aspect, the composition of a fluorinated organic carbonate and at least one Lewis acid is generally maintained at a temperature equal to or lower than 80° C., preferably in a range from 10° C. to 60° C.

In a fourth aspect of the first embodiment of the method of the present invention, the molar concentration of Lewis acid in the composition is during transport advantageously in a range of 0.1 to 100 ppm molar, relative to the total amount of fluorinated organic carbonate and Lewis acid, preferably in a range of 0.1 to 50 ppm molar, more preferably in a range of 0.1 to 25 ppm molar, very preferably in a range of 0.1 to 10 ppm molar relative to the total amount of fluorinated organic carbonate and Lewis acid, and most preferably in a range of 0.1 to 5 ppm molar relative to the total amount of fluorinated organic carbonate and Lewis acid.

In this fourth aspect, the composition of a fluorinated organic carbonate and at least one Lewis acid is generally maintained at a temperature equal to or lower than 80° C., preferably in a range from 10° C. to 60° C.

In a fifth aspect of the first embodiment of the method of the present invention, the molar concentration of Lewis acid in the composition is during formulation advantageously in a range of 0.1 to 100 ppm molar, relative to the total amount of fluorinated organic carbonate and Lewis acid, preferably in a range of 0.1 to 50 ppm molar, more preferably in a range of 0.1 to 25 ppm molar, very preferably in a range of 0.1 to 10 ppm molar relative to the total amount of fluorinated organic carbonate and Lewis acid, and most preferably in a range of 0.1 to 5 ppm molar relative to the total amount of fluorinated organic carbonate and Lewis acid.

In this fifth aspect, the composition of a fluorinated organic carbonate and at least one Lewis acid is generally maintained at a temperature equal to or lower than 80° C., preferably in a range from 10° C. to 60° C.

The composition of the present invention may contain at least one Lewis acid which is formed from a Lewis acid precursor.

For the purpose of the present invention, the term “Lewis acid precursor” refers to a substance that generates a Lewis acid when contacted with the composition of the present invention.

In general, the Lewis acid precursor in the method of the present invention is a metal selected from the Group IIB, IIIA, IIIB, IVA, IVB, VB, VIB or VIIIB Elements of the Periodic Table or a group of compounds including, but is not limited to, inorganic halides, inorganic oxides or inorganic carbonates, especially, of nickel, iron, copper and aluminium. Inorganic oxides are preferred Lewis acid precursors.

Typical examples of inorganic oxides are NiO, CuO, Fe₂O₃ and Al₂O₃.

The Lewis acid precursor may be a Lewis acid itself which forms another Lewis acid when in contact with the composition; SiO₂ is for example a Lewis acid and forms SiF₄—a Lewis acid, too—when in contact with HF.

In a first preferred aspect of this second embodiment of the present invention, said Lewis acid precursor can be provided to the composition by contact of said composition to at least one part containing the Lewis acid precursor.

The term “parts” has the same meaning as described in the first embodiment.

Typical examples of parts that contain Lewis acid precursors are parts selected from a group consisting of glass parts, ceramic parts or metal or metal alloy parts. In the present invention, the metal is generally selected from a group consisting of metals selected from the Group IIB, IIIA, IIIB, IVA, IVB, VB, VIB or VIIIB Elements of the Periodic Table. Preferably, the metal is selected from the Group IIIA, aluminum being most preferred.

In a particular aspect of the present invention, the Lewis acids or Lewis acid precursors contained in at least one part can be set free by reaction with HF. For example, glass or ceramic parts often contain compounds such as SiO₂, boron oxide, calcium hydroxide, sodium hydroxide and aluminum oxide. The fluorinated organic carbonates of the present invention are sensitive towards hydrolysis. Glass and ceramic parts with Si—O bonds are often sensitive to hydrogen fluoride because HF reacts under the formation of water and SiF₄. Water, as mentioned above, causes hydrolysis of the fluorinated organic carbonates of the present invention.

Since sometimes a very minute amount of water or HF adhering to glass or ceramics parts or present in the composition of the present invention cannot be excluded, a reaction as described above may take place. Thus, it is preferred that the content of HF and water each is equal to lower than 50 ppm by weight, more preferably, equal to or lower than 20 ppm by weight, and very preferably, equal to or lower than 10 ppm by molar, relative to the total amount of fluorinated organic carbonate and Lewis acid.

However, the aluminum oxide, contained for example in many types of glass, tends to form Al—F bonds when contacted with HF. The resulting components are stronger Lewis acids and may induce a further degradation of the fluorinated organic carbonates present in the composition of the present invention. The degradation products produced by this degradation, e.g., hydrofluoric acid, may etch the surface of the glass parts, thereby exposing additional quantities of aluminum oxide to the composition of the present invention. Subsequently, further degradation of the fluorinated organic carbonates can be induced. In some cases, the resulting degradation products may compromise the structural integrity of the glass parts.

Accordingly, it has been found that it is especially advantageous in the method of the present invention that the part, as defined above, which is in contact with the composition of the present invention is made, coated or lined with a material selected from the group consisting of HF-resistant metals such as stainless steel and HF-resistant alloys, polymeric materials, and combinations thereof; these materials are also generally inert to fluorinated carbonates. Said materials minimize the amount of Lewis acid and Lewis acid precursor that can be set free from the parts, as mentioned above. This is one possibility to maintain the molar concentration of Lewis acid in the composition of the present invention in the ranges described above.

For the purpose of the present invention, the part can be made of a single layer material or a multi-layer material.

For the purpose of the present invention, the term “multi-layer” is intended to include (i) materials constructed of more than one layer where at least two of the layers are constructed of different materials, i.e., materials that are chemically or structurally different, or materials that have different performance characteristics, wherein the layers are bonded to one another or otherwise aligned with one another so as to form a single sheet.

In one embodiment of the present invention, the material is a HF-resistant metal selected from a group consisting of stainless steel and HF-resistant alloys. In this embodiment, said material can be applied in the form of (i) a liner positioned on a part constructed from a different material, e.g., glass; or (ii) a coating applied to a part constructed from a different material, e.g., glass; or (iii) one layer of a multi-layer material, as above-discussed.

Non limiting examples of suitable HF-resistant alloys are selected from Monel, Inconel, Hastelloy, stainless steel and nickel. Preferably, the part is made, coated or lined with a material selected from the group consisting of stainless steel, HF-resistant alloys, polymeric materials and combinations thereof.

In another embodiment of the present invention, the material is an organic polymeric material.

As used herein, the term “organic polymeric material” includes polyalkylene polymers, partially or perfluorinated polymers, ionomeric resins, and chlorotrifluoroethylene polymers.

In this embodiment, said material can be applied in the form of (i) a liner positioned on a part constructed from a different material, e.g., glass; or (ii) a coating applied to a part constructed from a different material, e.g., glass; or (iii) one layer of a multi-layer material, as above-discussed.

Preferably, polyalkylene polymers are selected from PE (polyethylene) and polypropylene Good results were obtained with PE.

Preferably, partially or perfluorinated polymers are selected from PFA (perfluoroalkoxyalkane co-polymer), PTFE (polytetrafluoroethylene), PVDF (polyvinylidene difluoride) or chlorotrifluoroethylene polymers. As used herein, the term “ionomeric resin” refers to a thermoplastic polymer that is ionically cross-linked.

Suitable ionomeric resins are, for example, SURLYN® manufactured by DuPont.

Preferably, the reactor, pipes, purification apparatus such as stripping units, distillation columns, storage units, packaging, transport containers, apparatus used for manufacture of electrolyte mixtures or electrolyte solutions and other items, which come into contact with the composition of fluorinated organic carbonate and Lewis acid are made of stainless steel, Monel, Inconel, Hastelloy, nickel or other HF-resistant material, or of said polymeric material, or coated or lined with it.

If it is detected that the fluorosubstituted organic carbonate has an undesired content of a Lewis acid, it can be subjected to a purification step, e.g., to distillation.

The invention also relates to a composition comprising or consisting of a fluorinated organic carbonate and at least one Lewis acid or Lewis acid precursor wherein the molar concentration of at least one Lewis acid or Lewis acid precursor in the composition is as described above.

The definitions and preferences described above in the framework of the method for handling the composition of a fluorinated organic carbonate and a Lewis acid equally apply to the composition itself. The compositions comprise an inorganic Lewis acid in an amount of equal to or less than 500 ppm molar, preferably equal to or less than 100 ppm molar, more preferably, equal to or less than 50 ppm molar, especially preferably equal to or less than 25 ppm molar, very preferably, equal to or less than 10 ppm molar, most preferably, in a range of 0.1 to 5 ppm molar, and at least one fluorosubstituted alkylene carbonate or at least one fluorosubstituted dialkyl carbonate. The composition preferably comprises at least one fluorosubstituted organic carbonate selected from the group consisting of esters with the formula XC(F)(H)—C(O)OR wherein X is H or CH₃ and R denotes phenyl, allyl, 2,2,2-trifluoroethyl and 2-methoxyethyl, 1-fluoroethyl ethyl carbonate, bis(1-fluoroethyl)carbonate, 2-fluoroethyl ethyl carbonate, bis(2-fluoroethylcarbonate), 1,1-difluoroethyl ethyl carbonate, bis(1,1-difluoroethyl)carbonate, 2,2-difluoroethyl ethyl carbonate, bis(2,2-difluoroethyl)carbonate, 2,2,2-trifluoroethyl ethyl carbonate, bis(2,2,2-trifluorethylcarbonate), 1-fluoroethyl 2-fluoroethyl carbonate, 1-fluoroethyl 2,2-difluoroethyl carbonate, 1-fluoroethyl-2,2,2-trifluoroethyl carbonate, 1,1-difluoroethyl-2-fluoroethyl carbonate, 1,1-difluoroethyl-2-2-difluoroethyl carbonate, 1,1-difluoroethyl-2,2,2-trifluoromethylcarbonate, luoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one), difluoromethyl ethylene carbonate (or 4-difluoromethyl-1,3-dioxolane-2-one), 4-methyl-4-fluoro-1,3-dioxolane-2-one, cis-4-methyl-5-fluoro-1,3-dioxolane-2-one, trans-4-methyl-5-fluoro-1,3-dioxolane-2-one, 4-fluoromethyl-4-fluoro-1,3-dioxolane-2-one, 4-fluoromethyl-5-fluoro-1,3-dioxolane-2-one, 4-methyl-4,5-difluoro-1,3-dioxolane-2-one, Z-4-methyl-4,5-difluoro-1,3-dioxolane-2-one, and mixtures of two or more thereof. Most preferably, the fluorinated organic carbonates of the present invention are selected from the group consisting of fluoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one) and mixtures of two or more thereof. Preferably, they may comprise 0.1 ppm molar or more of the Lewis acid.

The content of HF is preferably equal to or lower than 10 ppm by weight by weight, and the content of H₂O is preferably equal to or lower than 10 ppm by weight.

Still a further aspect of the present invention are electrolyte compositions comprising the compositions of the present invention and an electrolyte salt for Li ion batteries. The electrolyte salt is preferably selected from the group consisting of LiPO₂F₂, LiBF₂C₂O₄ (LiFOB), LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O₈ (“LiBOB”), or Li(C₂F₅)PF₃, and especially LiPF₆. The content of the salt in the electrolyte composition is preferably 1±0.2 molar.

It has been found that the compositions of the present invention show an improved stability against degradation reactions.

The use of said compositions in for the manufacture of an electrolyte material for lithium ion batteries is another object of the present invention.

Thus, the composition as provided by the invention is suitable as one of the components of an electrolyte mixture or electrolyte solution for lithium ion batteries. To provide electrolyte mixtures or electrolyte solutions for lithium ion batteries, the composition of the present invention can be mixed with at least one other electrolyte salt and at least one other solvent or solvents.

Other suitable solvents are, e.g., lactones, formamides, pyrrolidinones, oxazolidinones, nitroalkanes, N,N-substituted urethanes, sulfolane, dialkyl sulfoxides, dialkyl sulfites, and trialkylphosphates or alkoxyesters pyrocarbonates, alkyl acetates, N,N-disubstituted acetamides, sulfoxides, nitriles, glycol ethers and ethers. The mixture of the fluorinated organic carbonate with ethylene carbonate, propylene carbonate is preferred. The mixtures optionally also include Li salt, e.g., LiPO₂F₂, LiBF₂C₂O₄ (LiFOB), LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O₈ (“LiBOB”), or Li(C₂F₅)PF₃, and especially LiPF₆. In particular, the electrolyte mixtures or electrolyte solutions are suitable for lithium ion batteries.

For example, an electrolyte salt like LiPO₂F₂, LiBF₂C₂O₄ (LiFOB), LiPF₆, LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O₈ (“LiBOB”), or Li(C₂F₅)PF₃, and one or more further solvents, such as dialkyl carbonates, e.g., dimethyl carbonate or ethyl carbonate, alkylene carbonate, e.g., ethylene carbonate, and/or any other desired solvents or additives are combined with the composition of the present invention in a vessel and homogenized to provide an electrolyte solution suitable for the manufacture of lithium ion batteries.

It is understood that the method of the invention and embodiments disclosed herein apply in a most preferred way to the method of handling a composition of fluoroethylene carbonate (or 4-fluoro-1,3-dioxolane-2-one) and a Lewis acid, and especially fluoromethyl methyl carbonate, difluoromethyl methyl carbonate, bis-(fluoromethyl)carbonate, fluoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one), difluoromethyl ethylene carbonate (or 4-difluoromethyl-1,3-dioxolane-2-one), 4-methyl-4-fluoro-1,3-dioxolane-2-one, cis-4-methyl-5-fluoro-1,3-dioxolane-2-one, trans-4-methyl-5-fluoro-1,3-dioxolane-2-one, 4-fluoromethyl-4-fluoro-1,3-dioxolane-2-one, 4-fluoromethyl-5-fluoro-1,3-dioxolane-2-one, 4-methyl-4,5-difluoro-1,3-dioxolane-2-one, Z-4-methyl-4,5-difluoro-1,3-dioxolane-2-one, fluoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one), esters with the formula XC(F)(H)—C(O)OR wherein X is H or CH₃ and R denotes phenyl, allyl, 2,2,2-trifluoroethyl and 2-methoxyethyl, and mixtures of two or more thereof.

According to one specific embodiment, a method for the manufacture of difluoroethylene carbonate, trifluoroethylene carbonate and tetrafluoroethylene carbonate is preferably performed such that formed difluoroethylene carbonate, trifluoroethylene carbonate and tetrafluoroethylene carbonate do not come into contact with glass and Lewis acids, especially Lewis acids which are present in glass or which are formed from constituents of glass in contact with HF.

Glass or ceramics contain Si—O bonds. In accordance with the specific embodiment difluoroethylene carbonate, trifluoroethylene carbonate and tetrafluoroethylene carbonate are sensitive towards hydrolysis. Glass and ceramics with Si—O bonds are often sensitive to hydrogen fluoride because HF reacts under the formation of water and SiF₄. Water, as mentioned above, causes hydrolysis of tri- and tetrafluoroethylene carbonates. Since probably a very minute amount of water or HF adhering to the glass items or in the fluorinated carbonate cannot be excluded a reaction as described above may take place. The Lewis acids or Lewis acid precursors contained in glass are set free and react with HF. For example, aluminium oxide is contained in many glasses and forms Al—F bonds when contacted with HF. The resulting components are Lewis acids and are considered to accelerate the decomposition of tri- and tetrafluoroethylene carbonates. It also assumed that the contact of tri- and tetrafluoroethylene carbonate with metals which contain Lewis acid precursors should be avoided.

Accordingly, it is preferred to perform the specific embodiment of the present invention not in apparatus which contain glass parts, ceramic parts or metal or metal alloy parts which contain Lewis acid precursors (e.g., aluminium or aluminium containing alloys) and are not resistant to HF and which could or would come into contact with the tri- or tetrafluoroethylene carbonate. It is preferred to perform the process according to this embodiment in apparatus containing only parts made of HF-resistant metals or polymeric material. Parts made from stainless steel, HF-resistant alloys like Inconel or Hastelloy are preferred, Suitable polymers are, for example, partially or perfluorinated polymers, as well as polyalkylene polymers and other types of polymers. For example, PFA (perfluoroalkoxyalkane co-polymer), PTFE (polytetrafluoroethylene), PE (polyethylene), or PVDF (polyvinylidene difluoride) are very suitable. The suitability of other polymers can easily be checked. Preferably, in the specific embodiment, the reactor, pipes, stripping units, distillation towers, storage tanks, and other items which come into contact with difluoroethylene carbonate, trifluoroethylene carbonate and tetrafluoroethylene carbonate are made of stainless steel, Inconel, Hastelloy or other resistant material, or of said polymeric material, or lined with it. The term “resistant” denotes in this specific embodiment materials which do not react with difluoroethylene carbonate, trifluoroethylene carbonate and tetrafluoroethylene carbonate in an undesired way.

As described above, difluoroethylene carbonate, trifluoroethylene carbonate and tetrafluoroethylene carbonate are contacted, according to the specific embodiment, during their manufacture preferably only with parts which do not cause the decomposition of these compounds. In another aspect of the specific embodiment, difluoroethylene carbonate, trifluoroethylene carbonate and tetrafluoroethylene carbonate are handled in this way not only during their manufacture, but from the moment of their manufacture until they are applied, e.g., as battery solvent, including storage, packaging, transport, additional purification steps, mixing with other components of electrolyte mixtures or electrolyte solutions, e.g., their mixture with ethylene carbonate, propylene carbonate, optionally also including Li salt, e.g., LiPF₆.

In this specific embodiment, the term “handling” denotes any step of life cycle of the compounds starting from the moment they come into existence by manufacture to the moment when they have lost any technical interest for use, i.e., when they are no longer applied, but ready for destruction, dumping or have otherwise become technically useless. The term “handling” especially includes the manufacture of the compounds, the storage of the compounds, and any step during which they are used. The term “handling” includes passing the carbonates during their manufacture or use through pipes, valves, mixing apparatus, filling them, or mixtures containing them, into battery housings etc.

The specific embodiment of the invention allows the manufacture of difluoroethylene carbonate, trifluoroethylene carbonate and tetrafluoroethylene carbonate in an easy and reliable manner. In preferred embodiments, the selective manufacture of difluoroethylene carbonate, the selective manufacture of trifluoroethylene carbonate and the selective manufacture of tetrafluoroethylene carbonate are possible.

Should the disclosure of any patents, patent applications, and publications which are incorporated herein by reference conflict with the description of the present application to the extent that it may render a term unclear, the present description shall take precedence.

This includes as well the composition comprising or consisting of fluoroethylene carbonate (or 4-fluoro-1,3-dioxolane-2-one) and a Lewis acid.

### EXAMPLES

The invention will now be illustrated by the examples here after without however limiting it thereto.

### Example 1

### Storage of Trifluoroethylene Carbonate in a Glass Bottle

Trifluoroethylene carbonate was stored in a glass bottle. It was observed that pressure built up. This indicates a decomposition of the compound. In the gas space, SiF₄ was determined. This indicates a reaction of SiO₂ from the glass of the bottle with HF under formation of water and SiF₄.

### Example 2

### Storage of Trifluoroethylene Carbonate in an Aluminium Vessel

Trifluoroethylene carbonate is stored in an aluminium vessel. Pressure formation is observed indicating a decomposition of the stored product.

### Example 3

### Storage of Tetrafluoroethylene Carbonate in a Pressure Resistant Glass Bottle

Trifluoroethylene carbonate is stored in a pressure resistant glass bottle. It is observed that pressure builds up. This indicates a decomposition of the compound. In the gas space, SiF₄ was determined. This indicates a reaction of SiO₂ from the glass of the bottle with HF under formation of water and SiF₄.

### Example 4

### Heating of Different Compositions of a F1 EC Compound with Different Lewis Acids or Lewis Acid Precursors

GENERAL PROCEDURE: A composition (25 ml) comprising crude F1EC comprising 0.3 ppm of Fe, 0.38 ppm of Ni, 0.2 ppm of Al and 0.12 ppm Cu (all molar ppm) and AlF₃ as typical Lewis acid was heated at 150° C. in a 50 ml autoclave for a specific period of time. The difference between the pressure at the start and the end pressure was determined. The data (r.t. means room temperature) are compiled in Table 1.

TABLE 1

| | AlF₃ | HF | H₂O | T | t | |
|---|---|---|---|---|---|---|
| Nr. | [ppm] | [ppm] | [ppm] | [° C.] | [h] | result |
| 1 | — | — | — | 50 | 24 | No pressure |
| 2 | 13200 | — | — | 50 | 24 | No pressure |
| 3 | — | — | — | 100 | 24 | 0.2 bar during heating |
| 4 | 13200 | — | — | 100 | 24 | 0.4 bar during heating |
| 5 | — | — | — | 150 | 24 | 0.2 bar during heating |
| 6 | 13200 | — | — | 150 | 24 | 1.0 bar during heating |
| 7 | — | — | — | 150 | 90 | 0.3 bar during heating |
| 8 | 13200 | — | — | 150 | 90 | 1.5 bar during heating |
| 9 | — | 700 | — | 150 | 24 | 0.8 bar during heating, |
| | | | | | | 0.1 bar at r.t., yellow color |
| 10 | 13200 | 700 | — | 150 | 24 | 4.5 bar during heating. |
| | | | | | | 1-7 bar at r.t., liquid |
| | | | | | | turned black |
| 11 | 2650 | 700 | — | 150 | 24 | 1.0 bar during heating, |
| | | | | | | 0.2 bar at r.t., liquid |
| | | | | | | turned brown/black |
| 12 | 265 | 700 | — | 150 | 24 | 1.0 bar during heating, |
| | | | | | | 0.2 bar at r.t., liquid |
| | | | | | | turned brownish |
| 13 | — | — | 580 | 150 | 24 | 0.5 bar during heating |
| 14 | 2650 | — | 580 | 150 | 24 | 0.5 bar during heating |

The examples demonstrate that the presence of a Lewis acid causes a pressure build-up (indicating decomposition) especially in the presence of water and HF, respectively.

1. A method for handling a composition of a fluorinated organic carbonate and at least one Lewis acid containing at least one atom selected from the group consisting of elements of Group IIB, IIIA, IIIB, IVA, IVB, V, VIB, and VIII of the Periodic Table, said method comprising:
maintaining the molar concentration of said Lewis acid in the composition in a range of equal to or less than 500 ppm molar relative to the total amount of fluorinated organic carbonate and Lewis acid.

2. The method according to claim 1 wherein the fluorinated organic carbonate is selected from the group consisting of fluorinated dimethyl carbonate, fluorinated ethylene carbonate, fluorinated propylene carbonate and mixtures of two or more of them.

3. The method according to claim 2 wherein the fluorinated organic carbonate is selected from the group consisting of fluoromethyl methyl carbonate, difluoromethyl methyl carbonate, bis-(fluoromethyl)carbonate, fluoroethylene carbonate (or 4-fluoro-1,3-dioxolane-2-one), 4,4-difluoro-1,3-dioxolane-2-one, cis-4,5-difluoroethylene carbonate, trans-4,5-difluoroethylene carbonate, 4,4,5-trifluoro-1,3-dioxolane-2-one, 4,4,5,5-tetrafluoro-1,3-dioxolane-2-one, fluoromethyl-ethylene carbonate (or 4-fluoromethyl-1,3-dioxolane-2-one), difluoromethyl ethylene carbonate (or 4-difluoromethyl-1,3-dioxolane-2-one), 4-methyl-4-fluoro-1,3-dioxolane-2-one, 4-methyl-5-fluoro-1,3-dioxolane-2-one, 4-fluoromethyl-4-fluoro-1,3-dioxolane-2-one, 4-fluoromethyl-5-fluoro-1,3-dioxolane-2-one, 4-methyl-4,4-difluoro-1,3-dioxolane-2-one, 4-methyl-4,5-difluoro-1,3-dioxolane-2-one, and mixtures of two or more thereof.

4. The method according to claim 1 wherein the Lewis acid comprises an inorganic Lewis acid selected from the group consisting of inorganic halides, inorganic oxides, and inorganic carbonates.

5. The method according to claim 4 wherein the inorganic halide has the formula MXₙ wherein M is a component selected from the group consisting of elements of Groups IIB, IIIA, IIIB, IVA, IVB, V, VIB, VIII of the Periodic Table and mixtures thereof, wherein X is a halogen, and wherein n is the atomic ratio of halogen to M and varies from 1 to 7.

6. The method according to claim 5 wherein X is fluoride.

7. (canceled)

8. The method according to claim 1, wherein the temperature of the composition does not exceed 200° C.

9. The method according to claim 1, wherein handling comprises an operation selected from the group consisting of manufacture, purification, storage, transport, and formulation.

10. The method according to claim 9 wherein handling is storage.

11. The method according to claim 1, wherein the Lewis acid within the composition is provided by contact of the fluorinated organic carbonate to at least one part during handling.

12. The method according to claim 1, wherein the Lewis acid in the composition is formed from a Lewis acid precursor.

13. The method according to claim 12 wherein the Lewis acid precursor is set free from at least one part.

14. The method according to claim 12 wherein the Lewis acid precursor is a metal selected from the group consisting of elements of Groups IIB, IIIA, IIIB, WA, IVB, VB, VIB, and VIIIB of the Periodic Table, or is a compound selected from the group consisting of inorganic halides, inorganic oxides, and inorganic carbonates.

15. The method according to claim 14 wherein the Lewis acid precursor is an inorganic oxide selected from the group consisting of Fe₂O₃, Al₂O₃, NiO, and CuO.

16. A composition of a fluorinated organic carbonate and at least one Lewis acid or Lewis acid precursor, wherein the molar concentration of at least one Lewis acid or Lewis acid precursor in the composition is equal to or lower than 500 ppm molar relative to the total amount of fluorinated organic carbonate and Lewis acid or Lewis acid precursor, and wherein the at least one Lewis acid or Lewis acid precursor contains at least one atom selected from the group consisting of elements of Groups IIB, IIIA, IIIB, IVA, IVB, V, VIB, and VIIIB of the Periodic Table.

17. A method for the manufacture of an electrolyte material, comprising using the composition of claim 16 as one of the components of said electrolyte material.

18. The method according to claim 17 wherein the composition is mixed with at least one electrolyte salt and at least one other solvent to provide an electrolyte mixture or electrolyte solution for lithium ion batteries.

19. The method according to claim 18 wherein the electrolyte salt is selected from the group consisting of LiPO₂F₂, LiBF₂C₂O₄ (LiFOB), LiPF₆, LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O₈ (“LiBOB”), and Li(C₂F₅)PF₃.

20. The method according to claim 18 wherein the solvent is selected from the group consisting of lactones, formamides, pyrrolidinones, oxazolidinones, nitroalkanes, N,N-substituted urethanes, sulfolane, dialkyl sulfoxides, dialkyl sulfites, and trialkylphosphates or alkoxyesters pyrocarbonates, alkyl acetates, N,N-disubstituted acetamides, sulfoxides, nitriles, glycol ethers, and ethers.

21. A method of handling difluoroethylene carbonate, trifluoroethylene carbonate and tetrafluoroethylene carbonate wherein difluoroethylene carbonate, trifluoroethylene carbonate and tetrafluoroethylene carbonate are not contacted with Lewis acids or Lewis acid precursors.

22. The method of claim 21 wherein difluoroethylene carbonate, trifluoroethylene carbonate and tetrafluoroethylene carbonate are not contacted with glass, ceramics, or aluminium parts containing aluminium alloys.

23. The method of claim 21 wherein difluoroethylene carbonate, trifluoroethylene carbonate and tetrafluoroethylene carbonate is contacted with stainless steel, a HF-resistant alloy, or a polymeric material.

24. The process of claim 23 wherein the polymeric material is perfluorinated.

25. The process of claim 1 comprising maintaining the molar concentration of said Lewis acid in the composition in a range of 0.1 to 500 ppm molar relative to the total amount of fluorinated organic carbonate and Lewis acid.

26. The process of claim 11 wherein the part is equipment used during handling.

27. The composition of claim 16 wherein the molar concentration of the at least one Lewis acid or Lewis acid precursor in the composition is in a range of 0.1 to 500 ppm molar relative to the total amount of fluorinated organic carbonate and Lewis acid or Lewis acid precursor.

28. A method for the manufacture of an electrolyte material, comprising using the composition of claim 27 as one of the components of said electrolyte material.

29. A method for handling a composition of a fluorinated organic carbonate and at least one Lewis acid containing at least one atom selected from the group consisting of elements of Groups IIB, IIIA, IIIB, IVA, IVB, V, VIB, and VIII of the Periodic Table, said method comprising:
maintaining the molar concentration of said Lewis acid in the composition in a range of about 1 to about 500 ppm molar with reference to the total amount of fluorinated organic carbonate and Lewis acid during purification, storage, transport and shelf life of said composition.
